(19) United States
(12) Patent Application Publication
(10) Pub. No.: US 2012/0002887 A1
(43) Pub. Date: Jan. 5, 2012

(54) SYSTEMS, METHODS, AND COMPUTER-READABLE MEDIA FOR DETERMINING BASIC PROBABILITY NUMBERS FOR DATA FUSION

(75) Inventors: David W. Gerts, Idaho Falls, ID (US); Timothy J. Roney, Idaho Falls, ID (US)

(73) Assignee: BATTELLE ENERGY ALLIANCE, LLC, Idaho Falls, ID (US)

(21) Appl. No.: 12/829,462

(22) Filed: Jul. 2, 2010

(51) Int. Cl. G06F 17/18; G06K 9/62

(52) U.S. Cl. 382/224; 702/181

(57) ABSTRACT

Systems, devices, methods, and computer-readable media relating to determining basic probability numbers for use within data fusion are disclosed. A method of defining a basic probability number may comprise measuring an intensity of a pixel of a radiograph wherein the pixel is associated with an interrogation space of an interrogation volume. The method may also include calculating an assumed intensity of the pixel for each possible configuration of a plurality of possible configurations for the interrogation space. Further, the method may include classifying each possible configuration as a possible target configuration if the measured intensity is within an error-factor of the assumed intensity. The method may further include defining a basic probability number of the pixel as a ratio of a number of possible target configurations to a number of possible configurations.

### GOVERNMENT RIGHTS

This invention was made with government support under Contract No. DE-AC07-051D14517 awarded by the United States Department of Energy. The government has certain rights in the invention.

### TECHNICAL FIELD

Embodiments of the present invention relate generally to data fusion and, more specifically, to systems, methods, and computer-readable media for determining basic probability numbers for use within data fusion methods.

### BACKGROUND

Sensor systems incorporating a plurality of data sources (e.g., multi-sensor systems) are widely used for a variety of military applications including ocean surveillance, air-to-air and surface-to-air defense (e.g., self-guided munitions), battlefield intelligence, surveillance and target detection (classification), and strategic warning and defense. In addition, multi-sensor systems are used for a plurality of civilian applications including condition-based maintenance, robotics, automotive safety, remote sensing, weather forecasting, medical diagnoses, and environmental monitoring (e.g., weather forecasting).

To obtain the full advantage of a multi-source system, an efficient data fusion method (or architecture) may be selected to optimally combine the received data from the multiple data sources (e.g., sensors). For military applications, especially target recognition, a sensor-level fusion process is widely used wherein data received by each individual sensor is fully processed at each sensor before being output to a data fusion processor.

The well-known Dempster-Shafer theory of evidential reasoning provides a means of combining information from different data sources to allow a system to make proper decisions. The Dempster-Shafer theory uses explicit representations of ignorance and conflict to avoid the shortcomings of classical Bayesian probability calculus. The Dempster-Shafer theory uses basic probability numbers, which represent the distribution of probability mass in a system (i.e., how strongly something is believed). The Dempster-Shafer theory, therefore, is based on obtaining degrees of belief for one question from subjective probabilities for a related question and uses Dempster-Shafer's rule for combining such degrees of belief when they are based on independent items or evidence.

A limitation of the Dempster-Shafer theory is determination of the basic probability numbers. Conventionally, basic probability numbers have been determined via expert knowledge, which may not be based on measured data and, therefore, may be subjective.

There is a need for enhanced methods and systems for determination of basic probability numbers for use within data fusion. Specifically, there is a need for methods, systems, and computer-readable media for determining basic probability numbers, for use within data fusion methods, based on measured data.

### BRIEF SUMMARY

An embodiment of the present invention comprises a method of defining a basic probability number for use within data fusion. The method may comprise measuring an intensity of a pixel of a radiograph wherein the pixel is associated with an interrogation space of an interrogation volume. The method may also include calculating an assumed intensity of the pixel for each possible configuration of a plurality of possible configurations for the interrogation space. Further, the method may include classifying each possible configuration as a possible target configuration if the measured intensity of the pixel is within an error-factor of the assumed intensity. The method may further include defining a basic probability number of the pixel as a ratio of a number of possible target configurations to a number of possible configurations.

Another embodiment of the present invention includes a method of defining a basic probability number of a pixel of a radiograph for use within the Dempster-Shafer theory. The method may include generating a plurality of possible configurations for an interrogation space associated with a pixel of a radiograph and determining an assumed intensity of the pixel for each possible configuration of the plurality of configurations. The method may further include comparing the assumed intensity of each possible configuration to a measured intensity of the pixel to determine whether each possible configuration comprises a target configuration. Moreover, the method may include dividing a number of target configurations by a number of possible configurations to define a basic probability number for the pixel.

Another embodiment of the present invention includes a method comprising detecting an intensity of each pixel of a radiograph generated by interrogating a target object with a first interrogation method and detecting an intensity of each pixel of another radiograph generated by interrogating the target object with at least one other interrogation method. Additionally, the method may comprise determining basic probability numbers for each pixel of the radiograph and each associated pixel of the other radiograph. A basic probability number for a pixel may be determined by measuring an intensity of the pixel and solving a multi-dimensional integral for each possible configuration of a plurality of possible configurations of an interrogation space associated with the pixel to calculate an assumed intensity of the pixel. Further, the basic probability number for the pixel may be determined by classifying each possible configuration as a possible target configuration if the intensity is substantially equal to the assumed intensity and defining a basic probability number of the pixel as a ratio of a number of possible target configurations to a number of possible configurations. Moreover, the method may include combining associated basic probability numbers from the radiograph and the other radiograph using Dempster-Shafer's orthogonal rule of combination.

Another embodiment of the present invention includes a system. The system may comprise a source configured to transmit a first signal into a target object and a detector configured to receive a second signal emitted from the target object and responsive to the first signal being transmitted into the target object. The system may further include a computer operably coupled to each of the source and the detector. The computer may be configured to determine an assumed intensity of a pixel of a radiograph for each possible configuration of a plurality of possible configurations of an interrogation space associated with the pixel. The computer may also be configured to compare the assumed intensity of each possible configuration to a measured intensity of the pixel to determine whether each possible configuration comprises a target configuration. Additionally, the computer may be configured to define a basic probability number of the pixel as a ratio of a number of target configurations to a number of possible configurations.

Yet another embodiment of the present invention includes a computer-readable storage medium storing instructions that, when executed by a processor, cause the processor to perform instructions for determining a basic probability number for use within a data fusion method according to an embodiment of the present invention.

### BRIEF DESCRIPTION OF THE DRAWINGS

FIG. 1 illustrates a block diagram of a conventional detection system;

FIG. 2 depicts a block diagram of a system including a computer, a target object and a plurality of detection systems in accordance with an embodiment of the present invention;

FIG. 3 illustrates a object including an explosive stimulant;

FIG. 4 illustrates an x-ray radiograph of the object illustrated in FIG. 3 taken at 300 keV;

FIG. 5 illustrates an x-ray radiograph of the object illustrated in FIG. 3 taken at 450 keV;

FIGS. 6A-6C illustrate basic probability numbers for the analysis window 240 of the radiograph 400 in FIG. 4;

FIGS. 7A-7C illustrate basic probability numbers for the analysis window 240 of the radiograph 500 in FIG. 5; and

FIGS. 8A-8C illustrate fused basic probability numbers for the radiographs illustrated in FIGS. 6A-6C and 7A-7C.

### DETAILED DESCRIPTION

In the following detailed description, reference is made to the accompanying drawings, which form a part hereof and in which is shown by way of illustration specific embodiments in which the invention may be practiced. These embodiments are described in sufficient detail to enable those of ordinary skill in the art to practice the invention, and it is to be understood that other embodiments may be utilized, and that structural, logical, and electrical changes may be made within the scope of the disclosure.

In this description, functions may be shown in block diagram form in order not to obscure the present invention in unnecessary detail. Furthermore, specific implementations shown and described are only examples and should not be construed as the only way to implement the present invention unless specified otherwise herein. Block definitions and partitioning of logic between various blocks represent a specific, non-limiting implementation. It will be readily apparent to one of ordinary skill in the art that the various embodiments of the present invention may be practiced by numerous other partitioning solutions. For the most part, details concerning timing considerations, and the like, have been omitted where such details are not necessary to obtain a complete understanding of the present invention in its various embodiments and are within the abilities of persons of ordinary skill in the relevant art.

When executed as firmware or software, instructions for performing the methods and processes described herein may be stored on a computer-readable medium. A computer-readable medium includes, but is not limited to, magnetic and optical storage devices such as disk drives, magnetic tape, CDs (compact disks), DVDs (digital versatile discs or digital video discs), and semiconductor devices such as RAM, DRAM, ROM, EPROM, and Flash memory.

Referring in general to the following description and accompanying drawings, various embodiments of the present invention are illustrated to show its structure and method of operation. Common elements of the illustrated embodiments are designated with like numerals. It should be understood that the figures presented are not meant to be illustrative of actual views of any particular portion of the actual structure or method but are merely idealized representations, which are employed to more clearly and fully depict the present invention.

A mathematical “inverse problem” may be defined as a problem wherein the answer is known, but the question is unknown. The embodiments described herein may be used to solve an “inverse problem.” More specifically, given a measurement (e.g., an intensity measurement of a pixel of a radiograph) taken in response to interrogation of a target object, the embodiments described herein may be used to assist in determining what one or more materials within the target object caused the measurement.

Moreover, as described more fully below, various embodiments of the present invention include systems, methods, and computer-readable media for determining basic probability numbers for use within a data fusion method (e.g., the Dempster-Shafer theory). More specifically, various embodiments of the present invention are related to systems, methods, and computer-readable media for calculating basic probability numbers for each individual pixel in a radiograph by determining a ratio of possible target configurations to possible configurations of an interrogation space associated with each pixel.

Before describing various embodiments of the present invention related to determining basic probability numbers for use within the Dempster-Shafer theory, a brief, general description of the Dempster-Shafer theory will first be provided. A conventional detection system and a detection system, according to an embodiment of the present invention, will each then be described. Thereafter, a method of determining basic probability numbers for use within a data fusion method (e.g., the Dempster-Shafer theory) in accordance with one or more embodiments of the present invention will be described.

The Dempster-Shafer theory is well known in the art and, therefore, in the following description thereof, some details may be omitted in order to avoid unnecessarily obscuring the invention. The Dempster-Shafer theory is a mathematical theory that allows data from multiple sources to be combined to arrive at a degree of belief. The Dempster-Shafer theory may be based on a) obtaining degrees of belief for one question from subjective probabilities of another, related question; and b) combining such degrees of belief based on independent items of evidence. A method of using the Dempster-Shafer theory may begin by determining a “question of interest.” For example, in the context of a method of detecting one or more “threat materials” (e.g., explosives or illicit drugs), a “question of interest” may comprise “is (are) there a threat(s) (e.g., an explosive material(s)) in a pixel of a radiograph of a target object?” Thereafter, a set of possible answers (also referred to as “hypotheses”) to the “question of interest” may be determined. These hypotheses may also be referred to as a “frame of discernment.” A hypothesis may include, for example, “explosive threat material,” “organic material,” “illicit drugs,” “electrical components,” “machine parts,” “paper products,” or “air.” In the context of explosive detection, a hypothesis may include, for example only, “explosive threat material.”

Furthermore, basic probability numbers for each data source may be determined. A set of possible subsets of Θ, which may be identified as 2^{Θ}, may be defined by the following equation:

2^{Θ}={A|A [symbol] Θ}. (1)

Furthermore, the belief function, Bel functions, satisfy the following three axioms:

Axiom 1:Bel(φ)=0; (2)

Axiom 2:Bel(Θ)=1; (3)

wherein φ is the null set.

Moreover, for any whole number n, and subsets A₁ . . . Aₙ, and all subsets of Θ:

$$Axiom 3 \text{:} Bel ( {⋃}_{i = 1}^{n} {A}_{i} ) \geq {\sum }_{i ⋐ \{ \begin{matrix}1 , 2 , … , n \\ \neq φ\end{matrix} \}} {( - 1 )}^{\vert I \vert + 1} Bel ( {⋃}_{i ∈ I} {A}_{i} ) . \qquad ( 4 )$$

Belief may be divided into one or more basic probability numbers (b(A)) and allocated to one or more subsets A, such that:

Σ{b(A)|A [symbol] Θ}=1. (5)

Furthermore, basic probability numbers may be related to belief functions by the following equation:

Bel(A)−Σ{b(B)|B [symbol] A}; (6)

wherein B represents proper subsets of A, and the summation is over all sets B.

Two or more pieces of evidence with basic probability numbers assigned thereto may be combined using Dempster-Shafer's orthogonal rule of combinations according to the following equations:

$$\begin{matrix}b = {b}_{1} ⊕ {b}_{2} ; and & ( 7 ) \\ b ( {A}_{i} ) = \frac{{\sum }_{{A}_{p} ⋂ {A}_{q} = {A}_{i}} {b}_{1} ( {A}_{p} ) {b}_{2} ( {A}_{q} )}{1 - {\sum }_{{A}_{p} ⋂ {A}_{q} = Ø} {b}_{1} ( {A}_{p} ) {b}_{2} ( {A}_{q} )} . & ( 8 )\end{matrix}$$

wherein the numerator indicates the summation of the combinations of basic probabilities for a given set of overlapping hypotheses and the denominator indicates one minus the summation of basic probabilities for the combinations of all the considered hypotheses.

Moreover, combined basic probability numbers may be evaluated to determine the strength of evidence of a specific hypothesis.

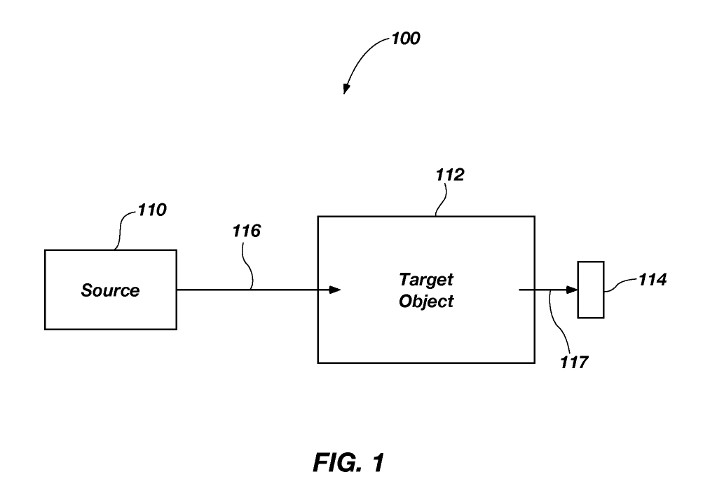

A conventional detection system will now be described. FIG. 1 illustrates a block diagram of a conventional detection system 100, which may be used for detection of one or more materials within a target object 112. Detection system 100, which includes a source 110 and a detector 114, may be configured for transmission radiography using, for example only, neutrons, bremsstrahlung x-rays, or gamma rays. As an example, source 110 may comprise an x-ray source configured to emit a signal 116 (e.g., an x-ray beam) toward target object 112. Furthermore, in this example, detector 114 may comprise an x-ray detector configured to detect a signal 117 (e.g., x-rays) emitted from target object 112. As another example, source 110 may comprise a neutron source configured to emit signal 116 (e.g., a stream of neutrons) toward target object 112. Furthermore, in this example, detector 114 may comprise a gamma ray detector configured to detect signal 117 (e.g., gamma rays) emitted from target object 112. FIG. 1 illustrates functional interactions. Actual physical placements of elements 110, 112, and 114 as well as directions of signals 116 and 117 may be in different configurations from what is illustrated in FIG. 1.

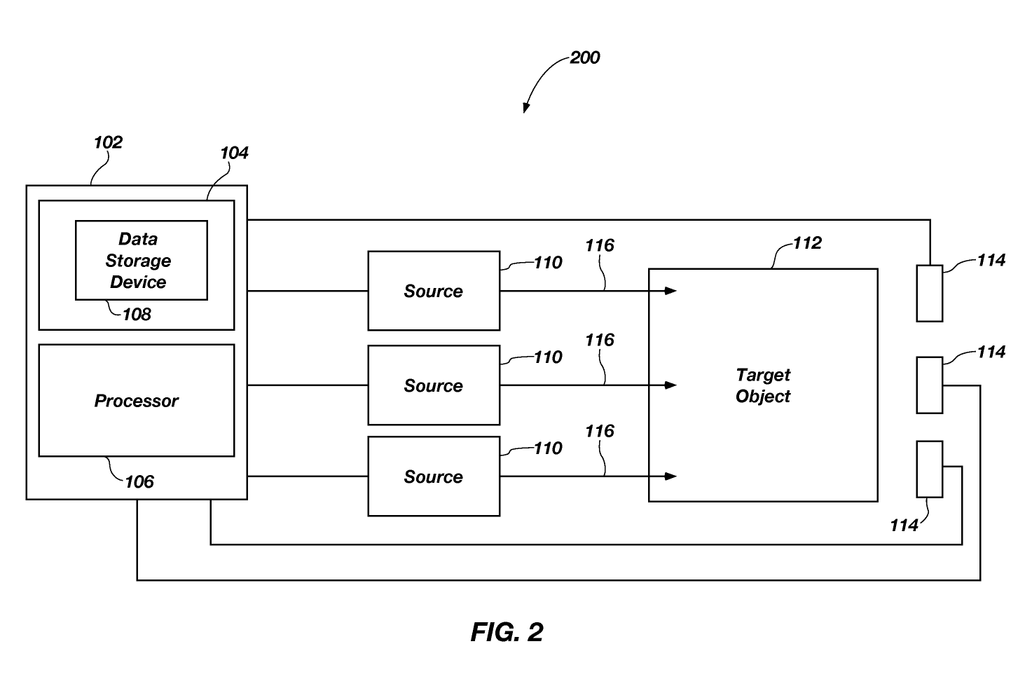

FIG. 2 illustrates a detection system 200 in accordance with an embodiment of the present invention. Detection system 200 includes a computer 102, target object 112, and a plurality of detection systems 100 (i.e., a plurality of sources 110, wherein each source 110 is coupled to computer 102 and is associated with a detector 114, which is also coupled to computer 102). Although detection system 200 is illustrated as having three detection systems (i.e., three sources with each source having an associated detector), a system including any number of detection systems 100 is within the scope of the present invention. Moreover, as with FIG. 1, FIG. 2 illustrates functional interactions among elements and is not intended to convey actual physical placement of elements.

Target object 112, which may also be referred to herein as an “object of interest” or an “interrogation volume” is, or includes, a material with respect to which a determination is being made regarding its elemental components. For example, target object 112 may be any item capable of transporting or smuggling explosives. As a more specific example, target object 112 may be a vehicle, a bag, a storage drum, a box, a container, or any combination thereof.

Computer 102 may include a processor 106 and a memory 104. Memory 104 may include a computer-readable medium (e.g., data storage device 108), which may include, but is not limited to, magnetic and optical storage devices, such as disk drives, magnetic tape, CDs (compact disks), DVDs, and semiconductor devices such as RAM, DRAM, ROM, EPROM, and Flash memory. As illustrated, computer 102 may be operably coupled to each source 110 and each detector 114 within detection system 200. According to an embodiment of the present invention, computer 102 may be configured to control operation of each source 110 and receive an output from each detector 114. Memory 104 may include one or more software applications configured for performing various methods described herein. For example, memory 104 may include one or more software applications configured for determining basic probability numbers for each pixel of each generated radiograph according to the methods described herein.

During operation of detection system 200, two or more sources 110 may transmit an associated signal 116 toward target object 112 and a response may be detected by each associated detector 114. Furthermore, each detector 114 may transmit associated data to computer 102. Upon receipt of data from one or more detectors 114, computer 102 may generate associated radiographs and determine basic probability numbers for each pixel of each generated radiograph in accordance with embodiments described herein. Thereafter, computer 102 may fuse data (i.e., combine associated basic probability numbers) according to Demspter's orthogonal rule of combination.

A method of determining a basic probability number for a pixel in a radiograph in accordance with an embodiment of the present invention will first be generally described. Thereafter, the method of determining a basic probability number for a pixel in a radiograph will be described in more detail. Generally, a method may include measuring an intensity of a pixel of a radiograph. Additionally, the method may include calculating, based on known data (e.g., the measured intensity of the pixel, a mass of an interrogation volume (e.g., mass of target object 112), a distance from a source (e.g., source 110) to an associated detector (e.g., detector 114), the number density of electrons associated with the pixel, or a combination thereof), and an assumed intensity of the pixel for each possible configuration of a plurality of possible configurations of an interrogation space (i.e., a space within an interrogation volume that is associated with a pixel of a radiograph). Furthermore, the method may include comparing the assumed intensity calculated for each possible configuration to the measured intensity of the pixel to determine whether each possible configuration may be considered a “possible target configuration.” Moreover, the method may include calculating a ratio of all “possible target configurations” to all “possible configurations” for the pixel.

More specifically, possible configurations of an interrogation space (i.e., a space within an interrogation volume that is associated with a pixel of a radiograph) may be generated by varying, through random number generation, the number of materials presumed to be present within the interrogation space, the types of material assumed to be present within the interrogation space, and the number of electrons associated with each material assumed to be present within interrogation space. Furthermore, each possible configuration may be integrated over known data, assumed data, or both, to calculate an assumed intensity of the associated pixel. For each specific possible configuration, the calculated assumed intensity of the pixel may then be compared to the measured intensity of the pixel and, if the intensities are within a user-defined error factor (e.g., substantially equal within the error factor), the specific possible configuration may be considered a “possible target configuration” and a “possible configuration.” If the intensities are not within a user-defined error factor, the specific possible configuration may be considered as only a “possible configuration.” After each “possible configuration” has been generated, and each calculated assumed intensity has been compared to the measured intensity, a basic probability number (“BPN”) for the pixel may be defined as the ratio of “possible target configurations” to all “possible configurations,” as discussed in more detail below and as provided in the following equation:

$$BPN = \frac{possible target configurations}{possible configurations} . \qquad ( 9 )$$

A method of determining a basic probability number for a pixel in a radiograph will now be described in more detail. As will be appreciated by a person having ordinary skill in the art, data, which is associated with a detection system (e.g., detection system 200), may be measured, or known, prior to determining basic probability numbers for each pixel within a radiograph. For example, intensities of each pixel within a radiograph may be measured. Furthermore, a mass of an interrogation volume (e.g., target object 112) may be measured according to known methods. Moreover, according to one embodiment, a mass of an interrogation volume may be divided by a number of pixels within a radiograph to determine an assumed mass associated with each pixel (i.e., an assumed mass of an interrogation space). For example, for a 3×3 pixel array having a total mass of 0.9 kg, even distribution of the mass would result in each pixel having 0.1 kg.

According to another embodiment, masses of each pixel may be at least partially related to the distribution of intensities of the pixels. More specifically, by comparing relative intensities of the pixels in a radiograph, a mass may be apportioned to each pixel. For example, if 90% of the measured attenuation is in the middle 10% of pixels of a radiograph, the middle 10% of pixels may be apportioned 90% of measured mass of the interrogation volume. More specifically, in the following example in which a pixel array has a total mass of 0.9 kg, a first pixel of the array has an intensity ratio of 0.0, a second pixel has an intensity ratio of 0.1, a third pixel has an intensity ratio of 0.2, a fourth pixel has an intensity ratio of 0.4, a fifth pixel has an intensity ratio of 0.3, and every other pixel in a radiograph has an intensity ratio of 0.0. Accordingly, in this example, the pixels with intensity ratios of 0.0 would be assigned a mass of 0 kg, the second pixel would be assigned a mass of 0.09 kg, the third pixel would be assigned a mass of 0.18 kg, the fourth pixel would be assigned a mass of 0.36 kg, and the fifth pixel would be assigned a mass of 0.27 kg.

Furthermore, a distance from a source (e.g., source 110) to an associated detector (e.g., detector 114) may also be measured. In addition, a ratio of an intensity of a transmitted signal (e.g., signal 116) to a detected signal (e.g., signal 117) may be determined. Moreover, a number density of electrons within an interrogation space associated with each pixel may be determined from the angle-integrated Klein-Nishina formula, as will be understood by a person having ordinary skill in the art.

According to an embodiment of the present invention, the above-described measured or known data, which may also be referred to as “known variables,” may be used to limit “configurations” to only “possible configurations.” For example, because the mass of the interrogation space may be known, only configurations that may have a mass substantially equal to the mass of the interrogation space are “possible configurations.” Furthermore, because a measured intensity of a pixel and a distance from a source (e.g., source 110) to an associated detector (e.g., detector 114) may be known, only configurations that exhibit these attributes may be “possible configurations.” As a more specific example, if an intensity measurement of a pixel is relatively high and a distance from a source (e.g., source 110) to a detector (e.g., detector 114) is relatively short, it may not be possible for an associated configuration to include only organic products (e.g., fish and flowers). Therefore, in this example, the configuration including only organic products would not be considered a “possible configuration” and, as a result, would not be generated and tested.

The following multi-dimensional integral of equation (10) may be solved for each possible configuration of an interrogation space to calculate an “Assumed Intensity” of a pixel associated with the interrogation space:

$${\int }_{Number of Materials} ( {\int }_{Material Type} [ {\int }_{Material Characteristic} \{ {\int }_{Distance} {e}^{- σ x} d x \} ] ) = Assumed Intensity . \qquad ( 10 )$$

Monte Carlo integration may be used for evaluation of multi-dimensional integrals. Monte Carlo integration is well known in the art and, therefore, will not be described in detail. However, a method of randomly identifying variables for generating a configuration of an interrogation space to be evaluated by equation (10) is described below.

One or more integrals of the multi-dimensional integral of equation (10) may be constrained (i.e., limited) by a variable (e.g., the “Number of Materials,” “Material Type,” or both), as described more fully below. With reference to equation (10), initially, a random number may be generated to determine an assumed “Number of Materials” present within an interrogation space. For example, if a number “3” is randomly generated, it may be assumed that the interrogation space includes “3” materials.

Thereafter, random numbers may be generated for each assumed material to determine a “Material Type” of each material. For example, if a number “2,” which is associated with organic materials, is randomly generated for the first of the three materials assumed to be present within the interrogation space, the first material may be assumed to be an organic material (e.g., flowers). As another example, if a number “5,” which is associated with “explosive threat” materials, is randomly generated for the second of the three materials assumed to be present within the interrogation space, the second material may be assumed to be an explosive threat material. It is noted that in the context of “threat material” detection, at least one “threat material” (e.g., explosive or illicit drug) may be assumed to be present within the interrogation space. The process of randomly generating numbers to determine the types of materials assumed to be present within the interrogation space may be repeated for each material assumed to be present to define a material type of each material. Accordingly, as will be appreciated by a person having ordinary skill in the art, the “Number of Materials” and “Material Type” variables may be used to constrain at least two integrals of equation (10).

It may be desirable to interrogate a target object (e.g., target object 112) for a specific material of interest (e.g., Nitroglycerin). Accordingly, in one embodiment of the present invention, a specific material of interest (e.g., Nitroglycerin) may be assumed to be present within the interrogation space. Therefore, in this embodiment, a random number may be generated to determine an assumed “Number of Materials” present within the interrogation space. Thereafter, for each material other than the specific material of interest, random numbers may be generated to determine a “Material Type” of the materials. Accordingly, in this example, the evaluation of equation (10) is not entirely random and, therefore, the variance associated with evaluation thereof may be reduced.

One or more integrals of the multi-dimensional integral of equation (10) may be constrained (i.e., limited) by known or measured data (e.g., “Material Characteristic,” “Distance,” or both), as described more fully below. With continued reference to equation (10), after determining an assumed number of materials present within an interrogation space and a material type for each material assumed to be present, at least one “Material Characteristic” may determined. The term “Material Characteristic” may include a combined mass of the one or more materials presumed to be present within the interrogation space, a number of electrons apportioned to each material assumed to be present within the interrogation space, or a combination thereof.

A number density of electrons in the interrogation space may be determined via use of the angle-integrated Klein-Nishina formula. More specifically, because the mass of the interrogation space, the distance from a source (e.g., source 110) to a detector (e.g., detector 114), and a ratio of an intensity of a transmitted signal (e.g., signal 116) to a detected signal (e.g., signal 117) is known, the angle-integrated Klein-Nishina formula may be used to calculate the number density of electrons in the interrogation space, as will be understood by a person having ordinary skill in the art. Furthermore, because each material assumed to be present within the interrogation volume has been identified as a type of material (e.g., organic, threat, machine part, etc.); each material may be assumed to have a known chemical composition and a known density. Accordingly, a number of electrons may be apportioned to each material assumed to be present within the interrogation space and a number density of electrons may be used as the “Material Characteristic” variable to constrain at least two integrals of equation (10). Moreover, a “Distance” as identified in equation (10) may represent a distance from a source (e.g., source 110) to an associated detector (e.g., detector 114) of a detection system 200 and may be used to constrain at least one integral of equation (10).

For each individual possible configuration, the calculated “Assumed Intensity” of the pixel may then be compared to the measured intensity of the pixel and, if the intensities are within a user-defined error factor (e.g., substantially equal), the individual possible configuration may be considered a “possible target configuration” and a “possible configuration.” If the intensities are not within the user-defined error factor, the individual possible configuration may be considered as only a “possible configuration.” After each possible configuration for a pixel has been generated and a calculated “Assumed Intensity” has been compared to a measured intensity, a basic probability number for the pixel may be defined as the ratio of all “possible target configurations” to all “possible configurations.” It is noted that in the context of explosive detection, a basic probability number for the pixel may be defined as the ratio of all “possible explosive threat configurations” to all “possible configurations.” This method of defining a basic probability number may be repeated for each pixel within a radiograph to determine a basic probability number for each pixel.

It is noted that basic probability numbers associated with different detection modalities (e.g., neutrons, gamma ray, and x-ray), or similar detection modalities at different energies, may be added together using Dempster-Shafer's orthogonal rule of combination as explained above.

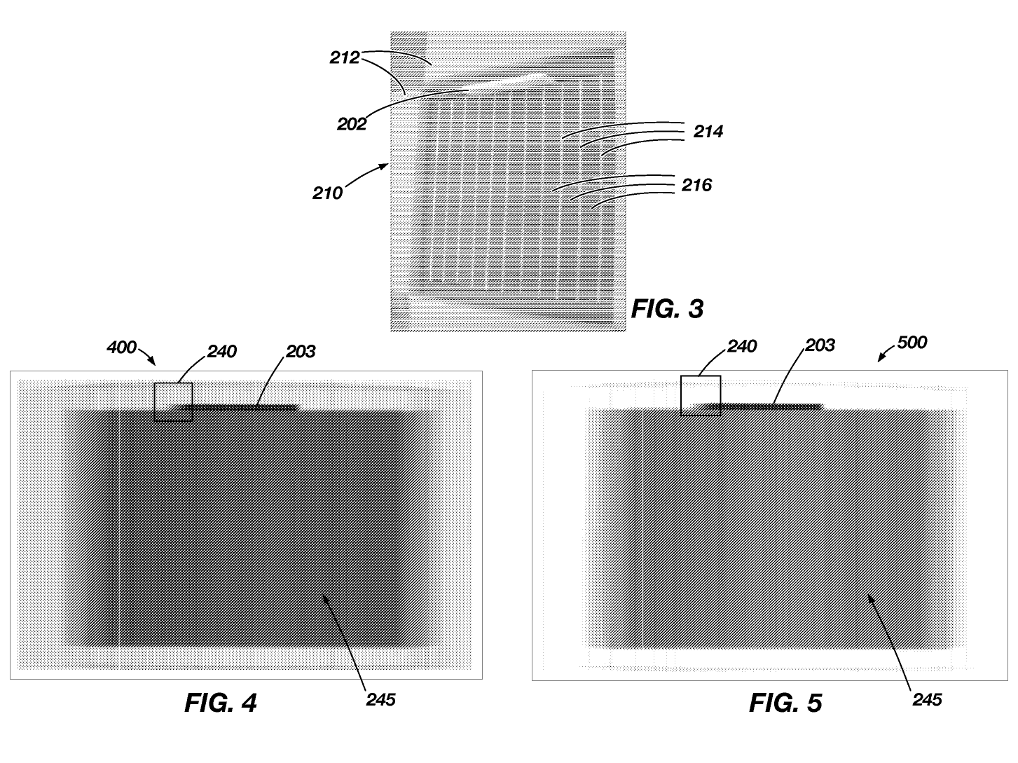

FIG. 3 illustrates an object 210 including a material 202 that models explosive stimulant. Elements 212 illustrate the flaps of an open corrugated cardboard box. Elements 214 model printed circuit boards, such as, for example, dielectric layers and conduction layers interleaved with an epoxy resin or other suitable material. Foam packaging material 216 is interposed between circuit boards 214 and around the perimeter of the box. Object 210 is used as one example of possible objects that may be used with embodiments of the present invention to illustrate an example of how the object may be processed by embodiments of the present invention. Of course, depending on the materials to be analyzed and configurations of the materials, other objects may be very different from object 210.

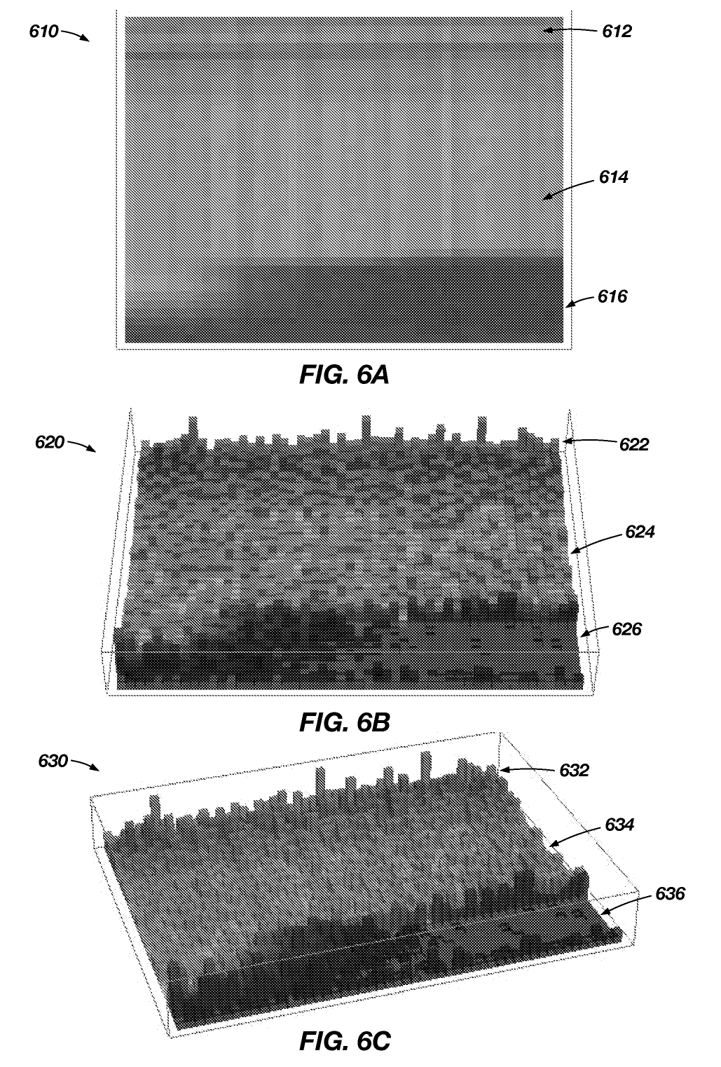

FIGS. 4 and 5 respectively illustrate radiographs 400 and 500 of object 210 illustrated in FIG. 3. FIG. 4 illustrates a radiograph 400 of object 210 taken at 300 keV and FIG. 5 illustrates a radiograph 500 of object 210 taken at 450 keV. Element 203 indicates the region where the modeled explosive stimulant material 202 is present in FIG. 3 and region 245 illustrates the regions where the foam packaging material 216 and circuit boards 214 are placed in FIG. 3. Analysis window 240 indicates a region of radiographs 400 and 500 that is used for additional basic probability analysis as is shown in FIGS. 6A-8C.

FIGS. 6A-6C illustrate basic probability numbers for the analysis window 240 of the radiograph 400 in FIG. 4. FIG. 6A is a top view 610 of the analysis window 240 and FIGS. 6B and 6C are different perspective views (620 and 630, respectively) of the analysis window 240 to better illustrate the various amplitudes of the various voxels within the analysis window 240. The amplitudes of the individual voxels indicate the relative likelihood of there being explosive stimulant at that location determined by basic probabilities according to an embodiment of the present invention. In other words, the taller the voxel, the more likely that there is explosive stimulant at that location. Regions 612, 622, and 632 illustrate a region generally corresponding to the flap 212 of the corrugated cardboard box near the top of analysis window 240 in FIG. 4. Regions 614, 624, and 634 illustrate a region generally corresponding to the foam packaging material 216 between the flap 212 of the corrugated cardboard box and the modeled explosive stimulant material 202. Regions 616, 626, and 636 illustrate a region generally corresponding to the modeled explosive stimulant material 202 and the combination of the foam packaging material 216 and circuit boards 214 below the modeled explosive stimulant material 202.

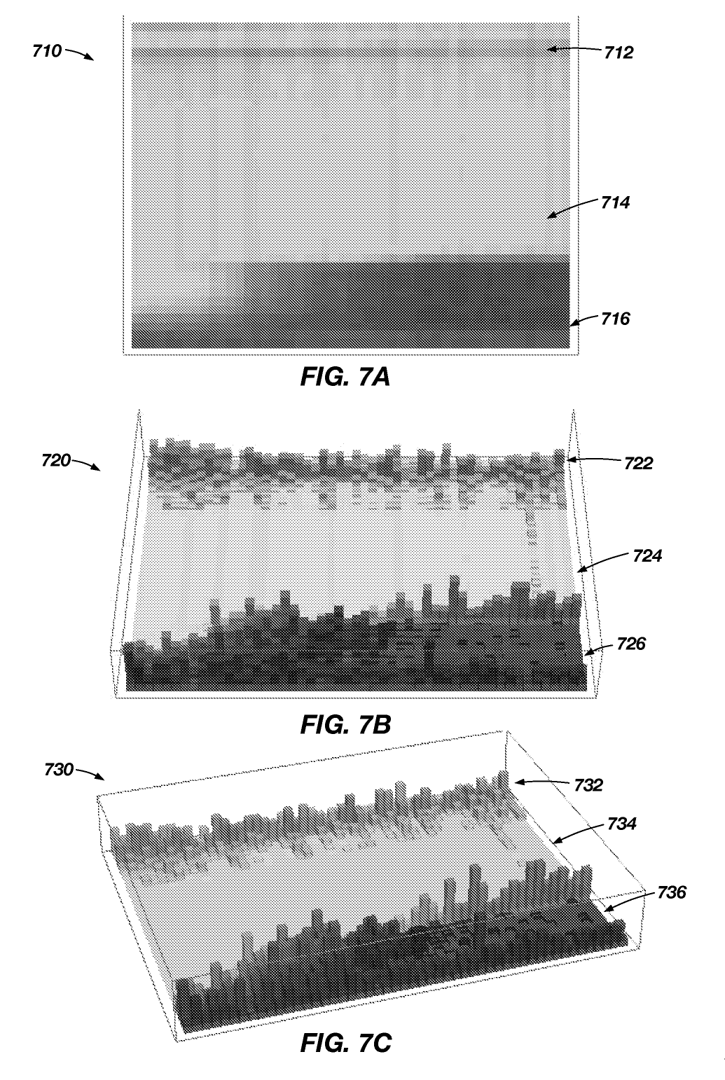

FIGS. 7A-7C illustrate basic probability numbers for the analysis window 240 of the radiograph 500 in FIG. 5. FIG. 7A is a top view 710 of the analysis window 240 and FIGS. 7B and 7C are different perspective views (720 and 730, respectively) of the analysis window 240 to better illustrate the various amplitudes of the various voxels within the analysis window 240. The amplitudes of the individual voxels indicate the relative likelihood of there being explosive stimulant at that location determined by basic probabilities according to an embodiment of the present invention. In other words, the taller the voxel, the more likely that there is explosive stimulant at that location. Regions 712, 722, and 732 illustrate a region generally corresponding to the flap 212 of the corrugated cardboard box near the top of analysis window 240 in FIG. 4. Regions 714, 724, and 734 illustrate a region generally corresponding to the foam packaging material 216 between the flap 212 of the corrugated cardboard box and the modeled explosive stimulant material 202. Regions 716, 726, and 736 illustrate a region generally corresponding to the modeled explosive stimulant material 202 and the combination of the foam packaging material 216 and circuit boards 214 below the modeled explosive stimulant material 202.

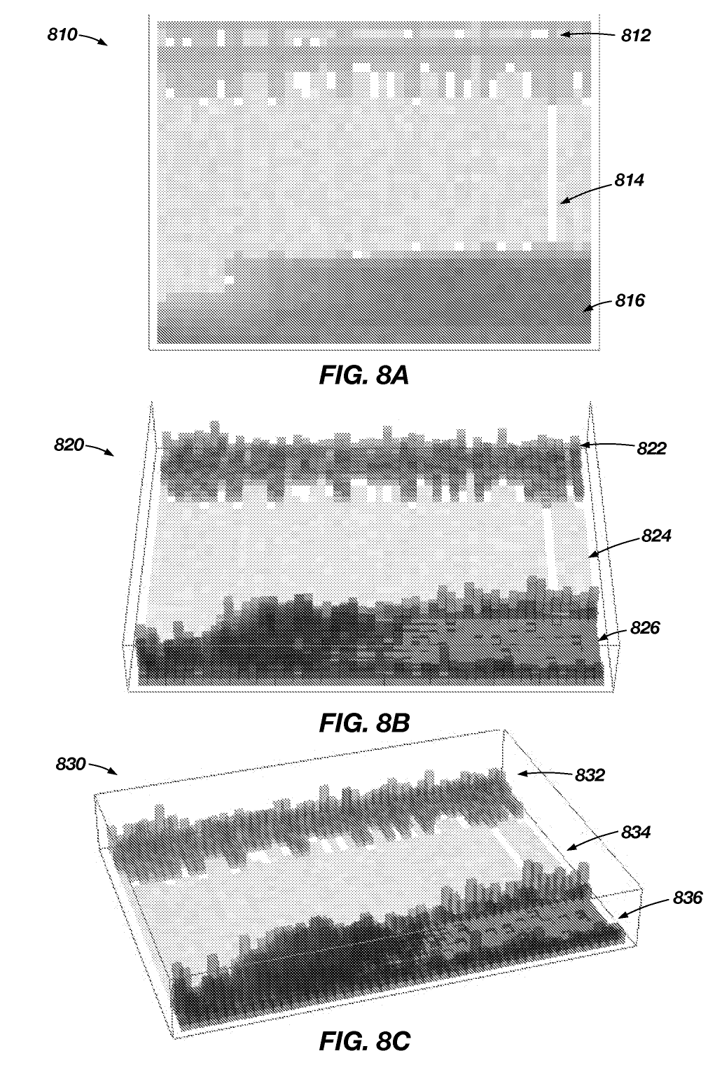

FIGS. 8A-8C illustrate fused basic probability numbers for the radiographs illustrated in FIGS. 6A-6C and 7A-7C. FIG. 8A is a top view 810 of the analysis window 240 and FIGS. 8B and 8C are different perspective views (820 and 830, respectively) of the analysis window 240 to better illustrate the various amplitudes of the various voxels within the analysis window 240. The amplitudes of the individual voxels indicate the relative likelihood of there being explosive stimulant at that location determined by basic probabilities according to equations 7 and 8. In other words, the taller the voxel, the more likely that there is explosive stimulant at that location. Regions 812, 822, and 832 illustrate a region generally corresponding to the flap 212 of the corrugated cardboard box near the top of analysis window 240 in FIG. 4. Regions 814, 824, and 834 illustrate a region generally corresponding to the foam packaging material 216 between the flap 212 of the corrugated cardboard box and the modeled explosive stimulant material 202. Regions 816, 826, and 836 illustrate a region generally corresponding to the modeled explosive stimulant material 202 and the combination of the foam packaging material 216 and circuit boards 214 below the modeled explosive stimulant material 202.

Although the embodiments described above are described in relation to explosive detection, the invention is not so limited. Rather, a person having ordinary skill in the art will understand that the systems and methods described above may be used for detection of other materials such as, for example only, illicit drugs, electronics, or organic materials, among other items.

While the present invention has been described herein with respect to certain embodiments, those of ordinary skill in the art will recognize and appreciate that it is not so limited. Rather, many additions, deletions, and modifications to the described embodiments may be made without departing from the scope of the invention as hereinafter claimed, including legal equivalents. In addition, features from one embodiment may be combined with features of another embodiment while still being encompassed within the scope of the invention as contemplated by the inventors.

What is claimed is:

1. A method of defining a basic probability number for use within data fusion, comprising:
measuring an intensity of a pixel of a radiograph, wherein the pixel is associated with an interrogation space of an interrogation volume;
calculating an assumed intensity of the pixel for each possible configuration of a plurality of possible configurations for the interrogation space;
classifying each possible configuration as a possible target configuration if the measured intensity of the pixel is within an error-factor of the assumed intensity; and
defining a basic probability number of the pixel as a ratio of a number of possible target configurations to a number of possible configurations.

2. The method of claim 1, wherein calculating comprises calculating the assumed intensity of the pixel for each possible configuration of the plurality of possible configurations by solving a multi-dimensional integral.

3. The method of claim 2, wherein solving the multi-dimensional integral comprises evaluating the multi-dimensional integral with a Monte Carlo integration technique.

4. The method of claim 3, wherein evaluating the multi-dimensional integral with a Monte Carlo integration technique comprises generating a random number to identify at least one variable at which to evaluate at least one integrand of the multi-dimensional integral.

5. The method of claim 2, wherein solving the multi-dimensional integral comprises solving a multi-dimensional integral having one integral constrained by a value equal to a distance between a source and an associated detector of a detection system configured for measuring the intensity of the pixel of the radiograph.

6. The method of claim 1, further comprising generating a random number to determine each of a number of materials assumed to be present within the interrogation space, a type of material for each of the number of materials assumed to be present within the interrogation space, and a number of electrons associated with each type of material present within the interrogation space.

7. The method of claim 1, wherein classifying each possible configuration as a possible target configuration if the measured intensity is within an error-factor of the assumed intensity comprises classifying each possible configuration as a possible target configuration if the measured intensity is substantially equal to the assumed intensity.

8. The method of claim 1, further comprising measuring a mass of the interrogation volume interrogated to generate the radiograph.

9. The method of claim 8, further comprising determining a mass of each interrogation space of the interrogation volume by dividing the mass of the interrogation volume by a number of pixels in the radiograph.

10. The method of claim 1, wherein classifying each possible configuration as a possible target configuration comprises classifying each possible configuration as a possible explosive threat configuration if the measured intensity is within an error-factor of the assumed intensity.

11. The method of claim 1, wherein defining the basic probability number comprises defining a basic probability of the pixel as a ratio of a number of possible explosive threat configurations to a number of possible configurations.

12. A method, comprising:
detecting an intensity of each pixel of a radiograph generated by interrogating a target object with a first interrogation method;
detecting an intensity of each pixel of another radiograph generated by interrogating the target object with at least one other interrogation method;
determining basic probability numbers for each pixel of the radiograph and for each associated pixel of the another radiograph, wherein a basic probability number for a pixel is determined by:
measuring an intensity of the pixel;
solving a multi-dimensional integral for each possible configuration of a plurality of possible configurations of an interrogation space associated with the pixel to calculate an assumed intensity of the pixel;
classifying each possible configuration as a possible target configuration if the intensity is substantially equal to the assumed intensity; and
defining a basic probability number of the pixel as a ratio of a number of possible target configurations to a number of possible configurations; and
combining associated basic probability numbers from the radiograph and the another radiograph using Dempster-Shafer's orthogonal rule of combination.

13. The method of claim 12, wherein interrogating the target object with the first interrogation method comprises interrogating the target object with a first detection modality, and interrogating the target object with the at least one other interrogation method comprises interrogating the target object with a second, different detection modality.

14. The method of claim 12, wherein interrogating the target object with the first interrogation method comprises interrogating the target object with a detection modality at a first energy, and interrogating the target object with the at least one other interrogation method comprises interrogating the target object with the detection modality at a second energy, different from the first energy.

15. A computer-readable storage medium for storing instructions that when executed by a processor cause the processor to perform instructions for determining a basic probability number for use within a data fusion method, the instructions comprising:
measuring an intensity of a pixel of a radiograph;
calculating an assumed intensity of the pixel for each possible configuration of a plurality of possible configurations of an interrogation space;
classifying each possible configuration as a possible target configuration if the measured intensity of the pixel is substantially equal to the assumed intensity of the pixel; and
defining a basic probability number of the pixel as a ratio of possible target configurations to possible configurations.

16. The computer-readable storage medium of claim 15, wherein calculating comprises calculating the assumed intensity of the pixel for each possible configuration of the plurality of possible configurations by solving an associated multi-dimensional integral.

17. The computer-readable storage medium of claim 15, wherein measuring the intensity of the pixel of the radiograph comprises measuring an intensity of a pixel of a radiograph generated by one of an x-ray detection system and a neutron detection system.

18. A method of defining a basic probability number of a pixel of a radiograph for use within the Dempster-Shafer theory, comprising:
generating a plurality of possible configurations for an interrogation space associated with a pixel of a radiograph;
determining an assumed intensity of the pixel for each possible configuration of the plurality of configurations;
comparing the assumed intensity of each possible configuration to a measured intensity of the pixel to determine whether each possible configuration comprises a target configuration; and
dividing a number of target configurations by a number of possible configurations to define a basic probability number for the pixel.

19. The method of claim 18, wherein generating the plurality of possible configurations comprises generating each possible configuration of the plurality of possible configurations using Monte Carlo integration.

20. The method of claim 18, wherein determining the assumed intensity of the pixel for each possible configuration of the plurality of configurations comprises solving a multi-dimensional integral for each possible configuration to determine the assumed intensity.

21. The method of claim 20, wherein solving the multi-dimensional integral for each possible configuration to determine the assumed intensity comprises solving a multi-dimensional integral for each possible configuration having at least one integral constrained by known data.

22. The method of claim 20, wherein solving the multi-dimensional integral for each possible configuration to determine the assumed intensity comprises solving a multi-dimensional integral for each possible configuration having at least one integral constrained by at least one randomly generated variable.

23. A system, comprising:
a source configured to transmit a first signal into a target object;
a detector configured to receive a second signal emitted from the target object and responsive to the first signal being transmitted into the target object; and
a computer operably coupled to each of the source and the detector and configured to:
determine an assumed intensity of a pixel of a radiograph for each possible configuration of a plurality of possible configurations of an interrogation space associated with the pixel;
compare the assumed intensity of each possible configuration to a measured intensity of the pixel to determine whether each possible configuration comprises a target configuration; and
define a basic probability number of the pixel as a ratio of a number of target configurations to a number of possible configurations.

24. The system of claim 23, wherein the computer is further configured to generate at least one random number to identify at least one variable of a possible configuration of the plurality of configurations.

25. The system of claim 23, wherein the computer is further configured to generate a random number to determine a number of materials associated with each possible configuration of the plurality of configurations.

26. The system of claim 23, wherein the computer is further configured to generate a random number to determine a material type of each material associated with each possible configuration of the plurality of configurations.
